(19) United States
(12) Patent Application Publication
(10) Pub. No.: US 2009/0119120 A1
(43) Pub. Date: May 7, 2009

(54) AUTOMATICALLY DETERMINING AND APPLYING OVERAGE FOR A CUSTOMER PRINT JOB

(75) Inventors: Rakesh Pandit, Irvine, CA (US); Geoff W. Harmon, Mission Viejo, CA (US)

Correspondence Address: YING CHEN;Chen Yoshimura LLP, 255 S. GRAND AVE., # 215, LOS ANGELES, CA, 90012, US

(73) Assignee: KONICA MINOLTA SYSTEMS LABORATORY, INC., Huntington Beach, CA (US)

(21) Appl. No.: 11/936,773

(22) Filed: Nov. 7, 2007

(51) Int. Cl. G06Q 10/00; G06F 17/00; G06K 1/00

(52) U.S. Cl. 705/1

(57) ABSTRACT

A print shop management system for automatically handling overage for customer print or copy jobs is described. An overage refers to extra copies of a customer job produced for internal use at the print shop. The print shop management system allows the operator to create overage formulas, each formula specifying a set of criteria and an overage value for customer jobs meeting the criteria. The system then automatically applies the overage formulas to each customer job to print the requested number of copies and the extra copies. The system can also keep track of actual resource usage for each job

### BACKGROUND OF THE INVENTION

1. Field of the Invention

This invention relates to a print shop management system and method, and in particular, it relates to a method for automatically determining and applying overage to a customer print job.

2. Description of Related Art

When a print shop prints a customer job, the customer will specify a copy count for the job. This customer-specified copy count value is the value upon which a price quote is made and for which the customer is charged. However, a print shop may desire to make extra copies of this job that are used internally to meet various print shop requirements. For example, a print shop may archive a hardcopy of each print job they create. As another example, a print shop, based on their tracking of printing errors, may make the assumption that on a run of a particular number of copies, an average of certain number of minor error occurs. To address these needs, extra copies of the final print job are desired. The extra copies are usually not directly billable to clients and are typically absorbed by the print shop.

### SUMMARY

Accordingly, the present invention is directed to a method and apparatus useful in a print shop for creating an extra copy (overage) formula and applying it programmatically to print jobs processed by the print shop.

An object of the present invention is to automatically process each customer job and add an appropriate overage to the job.

Additional features and advantages of the invention will be set forth in the descriptions that follow and in part will be apparent from the description, or may be learned by practice of the invention. The objectives and other advantages of the invention will be realized and attained by the structure particularly pointed out in the written description and claims thereof as well as the appended drawings.

To achieve these and/or other objects, as embodied and broadly described, the present invention provides a method used in a print shop for managing overage for production requests from customers, which includes: creating one or more overage formulas, each overage formula specifying a set of criteria and an overage value for customer production requests meeting the set of criteria; storing the one or more overage formulas on a data processing apparatus; and for each customer production request received by the data processing apparatus, applying the one or more overage formulas to determine an overage value for the customer production request, and producing a number of documents according to the production request, the number being equal to a copy count specified in the customer production request plus the overage value.

In another aspect, the present invention provides a computer program product that causes a data processing apparatus to perform the above method.

It is to be understood that both the foregoing general description and the following detailed description are exemplary and explanatory and are intended to provide further explanation of the invention as claimed.

### BRIEF DESCRIPTION OF THE DRAWINGS

FIG. 1 is a flow chart illustrating a method for handling overage for print jobs according to an embodiment of the present invention.

FIGS. 2 and 3 illustrate a graphic user interface used in the method of FIG. 1 for specifying overage formulas.

FIG. 4 illustrates a print shop system in which methods according to embodiments of the present invention may be used.

### DETAILED DESCRIPTION OF PREFERRED EMBODIMENTS

Embodiments of the present invention provide a method and apparatus useful in a print shop for creating extra copy (overage) formulas and applying them programmatically to print jobs processed by the print shop. In a preferred embodiment, this function is a part of a print shop management system, which includes a server executing print shop management software to manage the print jobs and control the various document production devices in the print shop.

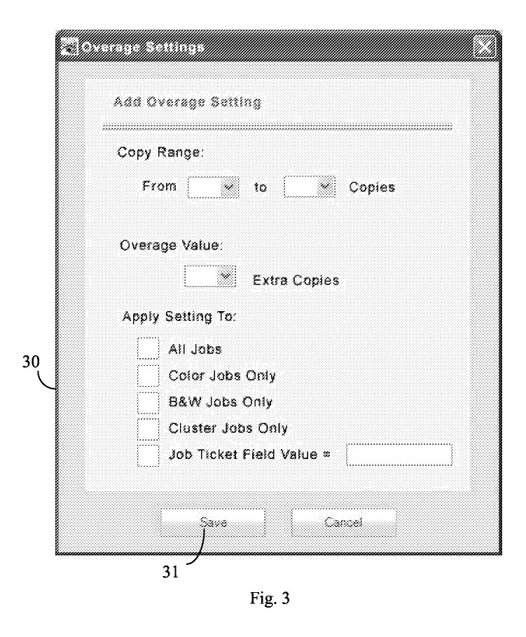

FIG. 4 schematically shows a print shop system having a plurality of document production devices 41 such as printers, copiers, scanners, finishing machines or the like, connected to a server 42 via a network 43. Here, the server may be any type of data processing apparatus, such as a personal computer, a workstation, and so on. One or more client computers 44 may also be connected to the server to enable print shop operators to interact with the server and the rest of the system. The server 42 is preferably also connected to an external network such as the Internet for receiving print jobs (i.e. print requests from customers and documents to be printed). The server 42, under the control of print shop management software, receives print jobs from customers and submits print commands and data to be printed to one or more machines 42. The print shop management software is preferably stored in a storage medium, such as an HD (Hard Disk) and a CPU (Central Processing Unit) of the server reads out the software to a RAM (Random Access Memory) of the server 42 to execute the same.

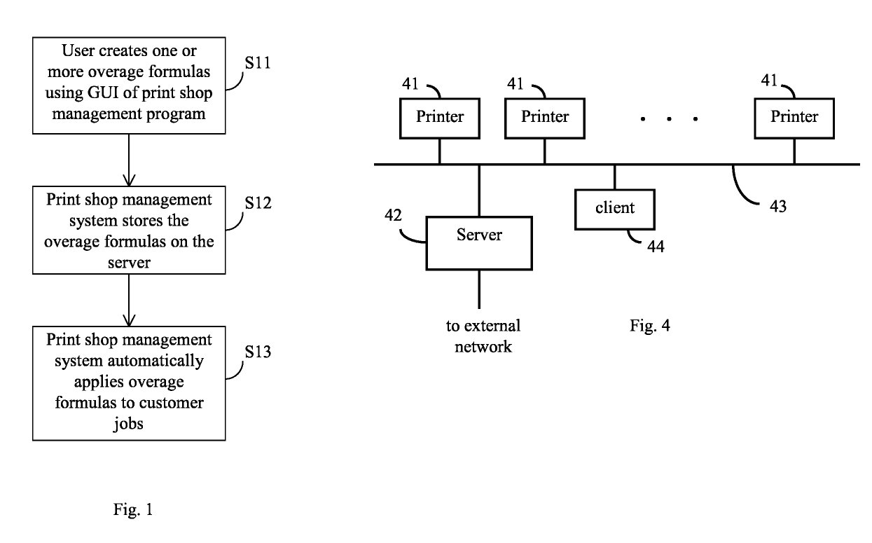

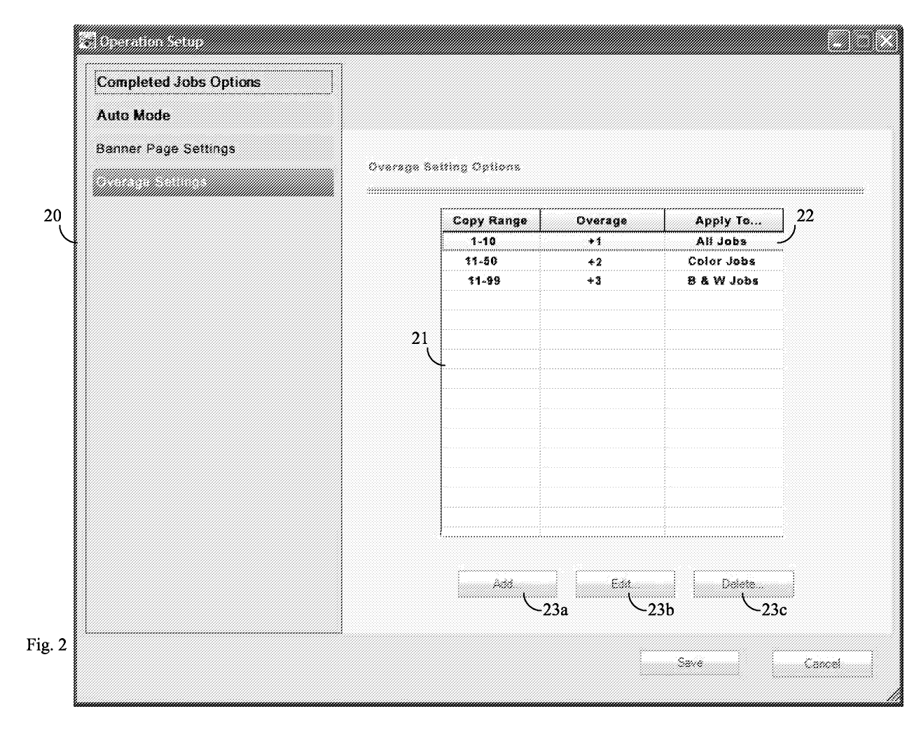

In addition to it other functions, the server running the print shop management software manages overage for print jobs. As shown in FIG. 1, a user (an operator at the print shop) first creates one or more overage formulas using a graphic user interface (GUI) displayed by the print shop management program (step S11). FIG. 2 is an example of a first window 20 of the GUI. The first window 20 has a table 21 to display a number of overage formulas 22 currently stored on the server. In this example, a number of overage formulas have already been created and saved in the storage medium. Each overage formula 22 specifies a set of criteria and the overage value (i.e. the number of extra copies to be made) for jobs meeting the criteria. In the illustrated example, the criteria include copy range (i.e. a range for the number of copies in the customer job) and a type of job (“Apply to . . . ” in FIG. 2, e.g. color jobs, black and white jobs, all jobs, etc.). For example, the first overage formula shown in FIG. 2 specifies that if the number of copies in the customer job is between 1 and 10, then the overage value is +1 for all jobs; the second overage formula specifies that if the number of copies in the customer job is between 11 and 50, and the job is a color job, then the overage value is +2; etc. The first GUI window 20 also includes buttons 23a, 23b and 23c to allow the user to add, edit or delete overage formulas.

If the user presses the “Add” button 23a, a second window 30 as illustrated in FIG. 3 will be displayed by the control under the print shop management program to allow the user to create a new overage formula. As shown in FIG. 3, using this window 30, the user can specify the copy range, overage, type of job and other criteria for the overage formula to be created. In the illustrated example, one of the criteria is a particular job ticket field value. A job ticket is a collection of parameters that describe the customer job, where the parameter may include the number of copies, orientation, input tray, output tray, finishing instructions, etc. Thus, for example, the user may enter a customer name, which is one of the parameters of the job ticket; as a result, this overage formula will apply only to jobs for the specified customer.

Referring back to FIG. 1, by the user's depression of the “Save” button 31 on the second window 30, the print shop management program stores the newly created overage formulas in the storage medium of the server (step S12). Then, when a customer job is submitted for printing, by the control under the print shop management program, the overage formulas are automatically called from the storage medium applied to each print job received by the print shop management system to determine the overage value (step S13). The print shop management program then instructs the printer to print a number of copies equal to the customer-specified copy count (i.e. the copy count value in the job ticket) plus the overage value. Preferably, print shop management program does not change the value of the copy count field in the job ticket itself.

Preferably, the print shop management program has a capability of tracking the amount of resources used for a customer job, such as the number of sheets of paper used, the type of paper, the amount of toner used, the number of staples used, etc. This provides information reflecting the actual resource usage for the job, including the extra copies. The resource usage information is stored in the storage medium by the server in accordance with the control under the print shop management program. For example, it may be added to the job ticket once the job has finished printing. The actual resource usage data may then be analyzed to enable the print shop to set a price structure that more accurately reflects and ultimately recaptures the cost incurred in making the extra copies.

In the above descriptions, print jobs are used as examples of customer jobs. Customer jobs may also be copy jobs. More generally, a customer job is a request for producing a specified number of copies of a document, either from digital data (print) or from an original hard copy (copy). The method describe above applies to both print and copy jobs (more generally, customer production requests). Also, the term “print shop” should be understood to broadly include any establishment that handles production requests, such as commercial print shops, document production centers within organizations, etc. The term “customer” should be understood to include any person or entity submitting a document production request to the print shop.

It will be apparent to those skilled in the art that various modification and variations can be made in the overage management method and apparatus of the present invention without departing from the spirit or scope of the invention. Thus, it is intended that the present invention cover modifications and variations that come within the scope of the appended claims and their equivalents.

1. A method used in a print shop for managing overage for production requests from customers, comprising:
creating one or more overage formulas, each overage formula specifying a set of criteria and an overage value for customer production requests meeting the set of criteria;
storing the one or more overage formulas on a data processing apparatus;
receiving a customer production request by the data processing apparatus, the customer production request specifying a copy count value;
the data processing apparatus automatically applying the one or more overage formulas to the customer production request to determine an overage value for the customer production request without changing the copy count value of the customer production request; and
producing a number of documents according to the production request, the number being equal to the copy count value specified in the customer production request plus the overage value.

2. The method of claim 1, wherein the set of criteria includes a range of the copy count specified in the customer production request.

3. The method of claim 1, wherein the set of criteria includes a type of the customer production request or a customer name.

4. The method of claim 1, further comprising collecting and storing actual resource usage information for producing the number of documents.

5. A computer program product comprising a computer usable medium having a computer readable code embodied therein for controlling a data processing apparatus, the computer readable program code configured to cause the data processing apparatus to execute a process for managing a print shop system, the print shop system including a plurality of printers, the process comprising the steps of:
creating one or more overage formulas, each overage formula specifying a set of criteria and an overage value for customer production requests meeting the set of criteria;
storing the one or more overage formulas on a data processing apparatus; and
for each customer production request received by the data processing apparatus, the customer production request specifying a copy count value, applying the one or more overage formulas to the customer production request to determine an overage value for the customer production request without changing the copy count value of the customer production request and
instructing a printer to produce a number of documents according to the production request, the number being equal to the copy count value specified in the customer production request plus the overage value.

6. The computer program product of claim 5, wherein the set of criteria includes a range of the copy count specified in the customer production request.

7. The computer program product of claim 5, wherein the set of criteria includes a type of the customer production request or a customer name.

8. The computer program product of claim 5, wherein the process further comprises collecting and storing actual resource usage information for producing the number of documents.

9. A method used in a print shop for managing overage for production requests from customers, comprising:
receiving a customer production request by a data processing apparatus, the customer production request specifying a copy count value;
the data processing apparatus automatically applying one or more overage formulas, each of which is stored on the data processing apparatus and specifies a set of criteria and an overage value for customer production requests meeting the set of criteria, to the customer production request to determine an overage value for the customer production request without changing the customer production request without changing the copy count value of the customer production request; and
producing a number of documents according to the production request, the number being equal to the copy count value specified in the customer production request plus the overage value.

10. The method of claim 9, wherein the set of criteria includes a range of the copy count specified in the customer production request.

11. The method of claim 9, wherein the set of criteria further includes a type of the customer production request or a customer name.

12. The method of claim 9, further comprising collecting and storing actual resource usage information for producing the number of documents.
